(19) United States
(12) Patent Application Publication
(10) Pub. No.: US 2025/0231411 A1
(43) Pub. Date: Jul. 17, 2025

(54) THERMALLY CONDUCTIVE COMPONENTS FOR WEARABLE HEADS-UP DISPLAY DEVICES

(71) Applicant: GOOGLE LLC, Mountain View, CA (US)

(72) Inventor: Daniel Adema, Kitchener (CA)

(21) Appl. No.: 18/849,093

(22) PCT Filed: Jan. 19, 2023
(86) PCT No.: PCT/US2023/011140

§ 371 Date: Sep. 20, 2024

Related U.S. Application Data
(60) Provisional application No. 63/324,789, filed on Mar. 29, 2022.

(51) Int. Cl. G02B 27/01; G02B 7/02

(52) U.S. Cl. CPC G02B 27/0176; G02B 7/028; G02B 27/0172; G02B 2027/011; G02B 2027/0178

(57) ABSTRACT

A wearable heads-up display (WHUD) device includes one or more electronic components that generate thermal energy when in operation, a support frame coupled to at least one of the electronic components, and at least one substantially transparent lens coupled to the support frame and made of materials with high thermal conductivity. The substantially transparent lens effectively conducts the thermal energy to the ambient environment, preventing overheating of the device. The support frame may be made of various materials and coupled to the substantially transparent lens via thermal interface materials.

### BACKGROUND

Wearable heads-up display (WHUD) devices such as smart glasses are thermally limited: the amount of heat (thermal energy) created by their integrated electronic components (e.g., light engine, display controller, etc.) must be rejected (channeled to the ambient environment) in order to avoid component damage or shutdown from heat accumulation. However, the size and form factor of such WHUD devices must also ideally conform to that of typical eyeglasses, which significantly limits the surface area available to outwardly channel that heat.

Previous solutions for smart glasses involve using some portion of the surface area of the glasses' temple arms and/or front frame to spread and reject heat. However, that surface area is limited, and corresponds to limited facilities for rejecting heat from a WHUD device.

### BRIEF SUMMARY OF EMBODIMENTS

In an embodiment, a wearable heads-up display (WHUD) device comprises one or more electronic components that, when in operation, generate thermal energy; a support frame coupled to at least one of the one or more electronic components; and at least one substantially transparent lens coupled to the support frame, wherein the at least one substantially transparent lens comprises materials having a thermal conductivity value exceeding 1.1 Watt per meter Kelvin (W/mK).

The at least one substantially transparent lens may comprise one or more of a group of materials that includes borosilicate, fused silica, sapphire, aluminum oxynitride (ALON), or silicon carbide.

The at least one substantially transparent lens may include a base material having a first thermal conductivity and one or more additional materials having a second thermal conductivity that is higher than the first thermal conductivity.

The base material may comprise one or more of a group that includes polycarbonate, borosilicate glass, or polymethyl methacrylate (PMMA), and the one or more additional materials may comprise one or more of a group that includes sapphire, aluminum oxynitride (ALON), silicon carbide, silver particulate, graphite, or graphene.

The base material may comprise one or more of a group that includes borosilicate, fused silica, sapphire, aluminum oxynitride (ALON), or silicon carbide, and the one or more additional materials may comprise one or more of a group that includes silver particulate, graphite, or graphene.

The support frame may comprise a front frame and one or more temple arms, such that at least the front frame comprises one or more of a group that includes a magnesium alloy, a titanium alloy, an aluminum alloy, a thermally conductive plastic, or a thermally conductive composite.

The support frame may be coupled to the at least one substantially transparent lens via one or more thermal interface materials, such that the one or more thermal interface materials comprise one or more of a group that includes thermal grease, thermal paste, or conductive adhesive.

The at least one substantially transparent lens may be directly coupled to the support frame and to at least one of the one or more electronic components.

The at least one substantially transparent lens may comprise one or more layers of an optical stack. The optical stack may comprise one or more ophthalmically corrective lenses and/or one or more augmented reality (AR) display components.

In an embodiment, a method comprises generating thermal energy at one or more electronic components coupled to a support frame of a wearable heads-up display (WHUD) device; and conducting the thermal energy to an ambient environment of the WHUD device via at least one substantially transparent lens coupled to the support frame, the at least one substantially transparent lens comprising materials having a thermal conductivity value of at least 1.1 Watts per meter Kelvin (W/mK).

Conducting the thermal energy to the ambient environment via at least one substantially transparent lens may include conducting the thermal energy via a substantially transparent lens comprising one or more of a group of materials that includes borosilicate, fused silica, sapphire, aluminum oxynitride (ALON), or silicon carbide.

Conducting the thermal energy to the ambient environment via at least one substantially transparent lens may include conducting the thermal energy via a substantially transparent lens comprising a base material having a first thermal conductivity and one or more additional materials having a second thermal conductivity that is higher than the first thermal conductivity. The base material may comprise one or more of a group that includes polycarbonate, borosilicate glass, or polymethyl methacrylate (PMMA), and the one or more additional materials may comprise one or more of a group that includes sapphire, aluminum oxynitride (ALON), silicon carbide, silver particulate, graphite, or graphene. The base material may comprise one or more of a group that includes borosilicate, fused silica, sapphire, aluminum oxynitride (ALON), or silicon carbide, and the one or more additional materials may comprise one or more of a group that includes silver particulate, graphite, or graphene.

The support frame may comprise a front frame and one or more temple arms, and the front frame may comprise one or more of a group that includes a magnesium alloy, a titanium alloy, an aluminum alloy, a thermally conductive plastic, or a thermally conductive composite.

The support frame may be coupled to the at least one substantially transparent lens via one or more thermal interface materials, and the one or more thermal interface materials may comprise one or more of a group that includes thermal grease, thermal paste, or conductive adhesive.

The at least one substantially transparent lens may be directly coupled to the support frame and to at least one of the one or more electronic components.

The at least one substantially transparent lens may comprise one or more layers of an optical stack that includes one or more of a group that includes one or more ophthalmically corrective lenses or one or more augmented reality (AR) display components.

In an embodiment, a method comprises coupling one or more electronic components to a support frame of a wearable device; and coupling at least one substantially transparent lens having an overall thermal conductivity value of at least 1.1 Watts per meter Kelvin (W/mK) to the support frame.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1-1 illustrates an example wearable heads-up display device that utilizes the surface area of its temple arms for primary heat rejection.

FIG. 1-2 depicts surface areas available for heat rejection and intra-device conduction in an example WHUD device constructed via techniques described herein in accordance with some embodiments.

FIG. 2 depicts a three-dimensional heat map of a typical polycarbonate lens that is mounted within a typical plastic support frame with approximately 50% contact between the support frame and lens.

FIG. 3 depicts a three-dimensional heat map of a typical polycarbonate lens mounted within a typical plastic support frame with substantially 100% contact between the support frame and lens.

FIG. 4 depicts a three-dimensional heat map of a magnesium-alloy support frame in accordance with one or more embodiments, coupled with approximately 50% contact to a typical polycarbonate lens.

FIG. 5 depicts a three-dimensional heat map of a magnesium-alloy support frame coupled with approximately 50% contact to a lens comprising an aluminum oxynitride (ALON) lens material, in accordance with some embodiments.

FIG. 6 depicts a three-dimensional heat map of a magnesium-alloy support frame coupled with approximately 100% contact to a lens comprising an ALON lens material, in accordance with some embodiments.

FIG. 7 depicts a three-dimensional heat map of a magnesium-alloy support frame coupled with substantially 100% contact with a transparent heatsink lens having an overall thermal conductivity of approximately 4 Watts per meter Kelvin (W/mK), in accordance with some embodiments.

FIG. 8 is an operational flow diagram illustrating operations for increasing an overall heat rejection efficiency in a device with one or more electronic components, in accordance with some embodiments.

### DETAILED DESCRIPTION

Embodiments of techniques described herein utilize material compositions with relatively high thermal conductivity for lenses of a WHUD device, in order to improve rejection of heat from a larger surface area of the device, as well as to improve the intra-device conduction (i.e., spreading) of that heat to alleviate heat accumulation in specific areas or components of the WHUD device. In certain embodiments, material compositions with relatively high thermal conductivity may be used for portions of the support frame. In addition, in certain embodiments additional techniques for coupling the support frame to the conductive lenses may be utilized.

Although some embodiments of the present disclosure are described and illustrated with reference to a particular example near-eye display system in the form of a WHUD, it will be appreciated that the apparatuses and techniques of the present disclosure are not limited to this particular example, but instead may be implemented in any of a variety of display systems using the guidelines provided herein. Moreover, although examples are described herein in the context of a near-eye display system comprising a support structure with a general shape and appearance (that is, form factor) of an eyeglasses or sunglasses frame, various embodiments may comprise a support structure having a different shape and appearance from such eyeglasses or sunglasses.

Instances of the term “or” herein refer to the non-exclusive definition of “or”, unless noted otherwise. For example, herein the phrase “X or Y” means “either X, or Y, or both”.

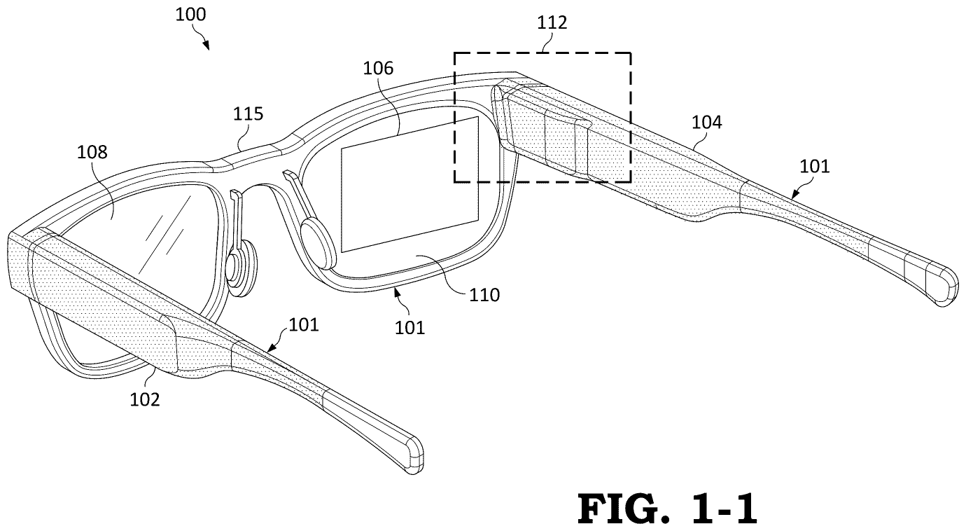

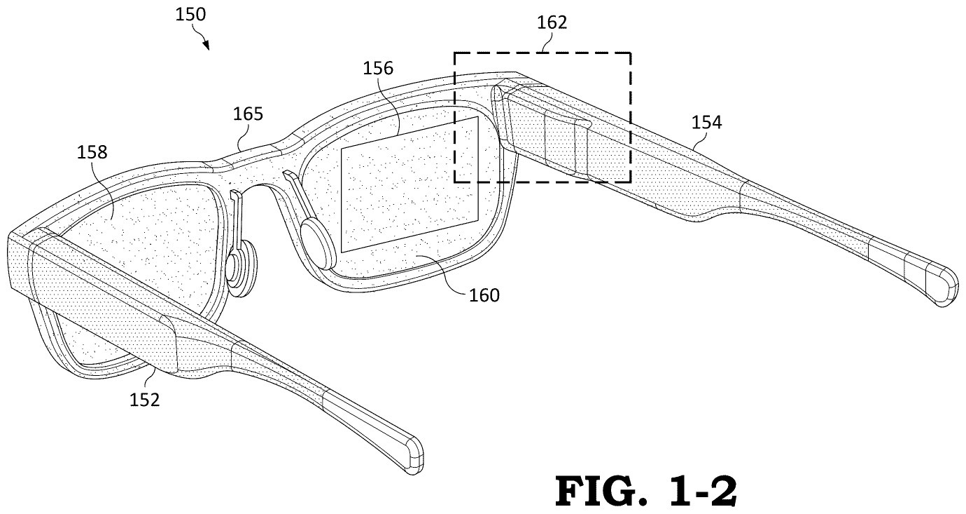

FIG. 1-1 illustrates an example wearable heads-up display device 100 using temple arms 102, 104 of the display device 100 as its primary surface areas for heat rejection, such as in a WHUD device utilizing a typical lens material (e.g., polycarbonate material, polymethyl methacrylate (PMMA) material, or other material with a relatively low thermal conductivity) for its lenses and typical acetate or plastic (which are also associated with relatively low thermal conductivity) for its front support frame.

The WHUD device 100 has a front frame 115 that is coupled to temple arms 102, 104. The front frame 115 and temple arms 102, 104 are collectively referred to herein as support structure 101. In the depicted example, the temple arms 102, 104 are shaded to indicate the surface area available for primary heat rejection. In the depicted example, temple arm 104 houses a projector (e.g., a laser projector, a micro-LED projector, a Liquid Crystal on Silicon (LCOS) projector, or the like). The projector (not shown) is configured to project images toward the eye of a user via a waveguide, such that the user perceives the projected images as being displayed in a field of view (FOV) area 106 of a display at one or both of lens elements 108, 110. During operation, the projector housed in the temple arm 104 typically produces thermal energy (heat). In order to avoid component damage or shutdown from heat accumulation over time, such heat is channeled away from the WHUD device 100. However, because the front frame 115 and lens elements 108, 110 are comprised of typical polycarbonate (PC) materials, the WHUD device 100 relies on the surface area of temple arms 102, 104 for such heat rejection. Moreover, due to the distance and lack of thermal interface between temple arms 102 and 104, the surface area of temple arm 102 is unlikely to provide significant heat rejection for thermal energy produced by components housed within the temple arm 104, further limiting the available surface area for primary heat rejection.

The support structure 101 contains or otherwise includes various electrical, electronic, and/or optoelectronic components to facilitate the projection of such images toward the eye of the user, such as a projector and a waveguide. In some embodiments, the support structure 101 further includes various sensors, such as one or more front-facing cameras, rear-facing cameras, other light sensors, motion sensors, accelerometers, and the like. In some embodiments, the support structure 101 includes one or more radio frequency (RF) interfaces or other wireless interfaces, such as a Bluetooth™ interface, a WiFi interface, and the like. Further, in some embodiments, the support structure 101 further includes one or more batteries or other portable power sources for supplying power to the electrical components of the WHUD device 100. In some embodiments, some or all of these components of the WHUD device 100 are fully or partially contained within an inner volume of support structure 101, such as within the temple arm 104 in region 112 of the support structure 101. As with the projector housed in temple arm 104, some or all of the projection-facilitating components, the sensors, the wireless interface(s), and the power circuitry (all of which may be collectively referenced herein as electronic components for purposes of brevity) generate heat during operation of the WHUD device 100, which relies almost entirely on the surface area of temple arms 104, 102 for rejecting that heat (channeling the heat into the ambient environment).

The projector is communicatively coupled to a display controller (not shown) and a non-transitory processor-readable storage medium or memory storing processor-executable instructions and other data that, when executed by the controller, cause the display controller to control the operation of the projector. In some embodiments, the display controller is communicatively coupled to one or more processors (not shown) that generate content to be displayed at the WHUD device 100. The projector outputs display light toward the FOV area 106 of the WHUD device 100 via the waveguide. In some embodiments, at least a portion of an outcoupler of the waveguide overlaps the FOV area 106. Herein, the range of different user eye positions that will be able to see the display is referred to as the eyebox of the display. As with the other components of the WHUD device 100 discussed above, at least some of the display controller and the one or more processors generate heat during operation, which is almost entirely dependent on the surface area of temple arms 104, 102 (and as discussed above, largely on that of temple arm 104) for rejection into the ambient environment.

One or both of the lens elements 108, 110 are used by the WHUD device 100 to provide an augmented reality (AR) display in which rendered graphical content can be superimposed over or otherwise provided in conjunction with a real-world view as perceived by the user through the lens elements 108, 110. For example, a projection system of the WHUD device 100 uses light to form a perceptible image or series of images by projecting the display light onto the eye of the user via a projector of the projection system, a waveguide formed at least partially in the corresponding lens element 108 or 110, and one or more optical elements (e.g., one or more scan mirrors, one or more optical relays, or one or more collimation lenses that are disposed between the projector and the waveguide or integrated with the waveguide), according to various embodiments. Thus, each of the lens elements 108, 110 is sufficiently transparent to allow a user to see through the lens elements to provide a field of view of the user's real-world environment, such that the display light output by the waveguide forms an image that appears superimposed over at least a portion of the real-world environment.

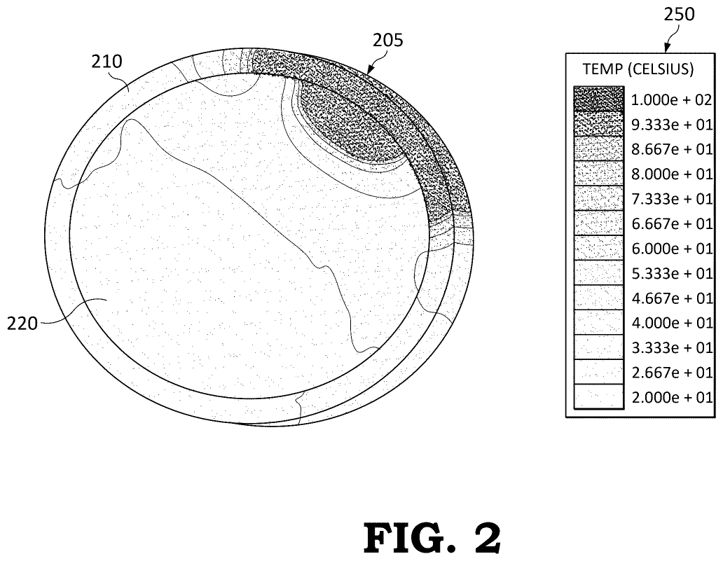

In contrast to the WHUD device 100 of FIG. 1-1, FIG. 1-2 depicts surface areas available for heat rejection and intra-device conduction in an example WHUD device 150 in which some or all of the material composition for the transparent lens elements 108, 110 and/or front support frame 115 have been replaced with materials having a significantly higher thermal conductivity, in accordance with various embodiments.

The WHUD device 150 includes a front frame 165 that is coupled to temple arms 152, 154. In a similar manner to that described above with respect to corresponding components of the WHUD device 100, in the depicted embodiment temple arm 154 houses a projector (not shown) that is configured to project images toward the eye of a user via a waveguide, such that the user perceives the projected images as being displayed in a field of view (FOV) area 156 of a display at one or both of lens elements 158, 160. In addition, the temple arm 154 additionally houses (such as in region 162) various components to facilitate the projection of images toward the eye of the user, various sensors, and one or more wireless interfaces, all of which components typically produce heat during operation. As with temple arms 102, 104 in FIG. 1-1, the temple arms 152, 154 are shaded to indicate surface areas available for heat rejection. However, because some or all of the front frame 165 and lens elements 158, 160 comprise materials having higher thermal conductivity (and are shaded accordingly in the embodiment of FIG. 1-2), the WHUD device 150 does not rely on the surface area of those temple arms 152, 154 for primary heat rejection.

In particular, in the depicted embodiment the WHUD device 150 has a front frame 165 that is coupled to temple arms 152, 154 and that supports lens elements 158, 160. In contrast to the lens elements 108, 110 of WHUD device 100, lens elements 158, 160 are transparent heatsink lens elements, eschewing low thermal conductivity lens materials in favor of a transparent base material of higher thermal conductivity such as sapphire, aluminum oxynitride (ALON), silicon carbide, or other transparent material having a higher thermal conductivity. In certain embodiments, additional filler materials such as silver particulate, graphite, graphene, or other materials may be selectively added to a base lens material in order to further increase the thermal conductivity of the lens elements 158, 160. In either case, the incorporating WHUD device 150 gains significant surface area for the rejection and intra-device conduction of heat via the resulting transparent heatsink.

In the depicted embodiment, some or all of the front frame 165 and temple arms 152, 154 comprise materials with a relatively high thermal conductivity. Non-limiting examples of such materials include aluminum, titanium, magnesium alloys, thermally conductive plastics, and thermally conductive composite materials. In this manner, intra-device conduction away from heat source components of the WHUD device 150 (and into the transparent heatsink lens elements 158, 160) is further increased, and increases the overall heat rejection of the WHUD device 150.

Table 1 notes thermal conductivity values (in Watts per meter Kelvin) respectively associated with each of several typical eyeglass lens materials (polycarbonate, PMMA, Borosilicate, and fused silica), followed by the corresponding thermal conductivity values respectively associated with each of several transparent materials (ALON, Sapphire, and silicon carbide) for use as lenses in embodiments of WHUD devices constructed in accordance with techniques described herein:

TABLE 1

| Material | Thermal Conductivity (W/mk) |
|---|---|
| Polycarbonate | 0.173 |
| PMMA | 0.167 − 0.22 |
| Borosilicate | 1.114 |
| Fused Silica | 1.38 |
| Aluminum oxynitride (ALON) | 13 |
| Sapphire | 40 |
| Silicon carbide | 120 |

In certain embodiments, the transparent heatsink lens elements 158, 160 are configured for use in the WHUD device as an ophthalmic lens for vision correction. In other embodiments, the transparent heatsink lens elements 158, 160 are disposed as one or more of multiple layers in an optical stack for the WHUD device, such as to place the transparent heatsink lens elements 158, 160 in front or behind such an ophthalmically corrective lens (which may be comprised of a typical lens material and/or of a material having a higher thermal conductivity). The optical stack may further include one or more additional display components of the incorporating WHUD device, such as a display combiner, waveguide and/or light guide, etc. Moreover, in certain embodiments the heat transfer from the optical stack as a whole to the ambient environment is further improved by utilizing one or more coatings, surface treatments, or microstructures with respect to one or more layers of the optical stack, including but not limited to the lens elements 158, 160.

FIG. 2 depicts a three-dimensional (3D) heat map of a typical polycarbonate lens 220 that is mounted within a typical plastic support frame 210, which are respectively analogous to front frame 115 and lens element 110 of WHUD device 100 in FIG. 1-1. The combination of the PC lens 220 and the plastic support frame 210 is coupled at or near heat input 205 to one or more heat sources (not shown) of a WHUD device (e.g., WHUD device 100 of FIG. 1-1). As shown, the heat provided at heat input 205 by the components of the WHUD device (and indexed via heat index scale 250) accumulates in areas of the polycarbonate lens 220 directly coupled to that heat input, as the polycarbonate lens 220 and plastic support frame 210 generally fail to reject such heat to the ambient environment—or even to conduct that heat away from the heat source components themselves.

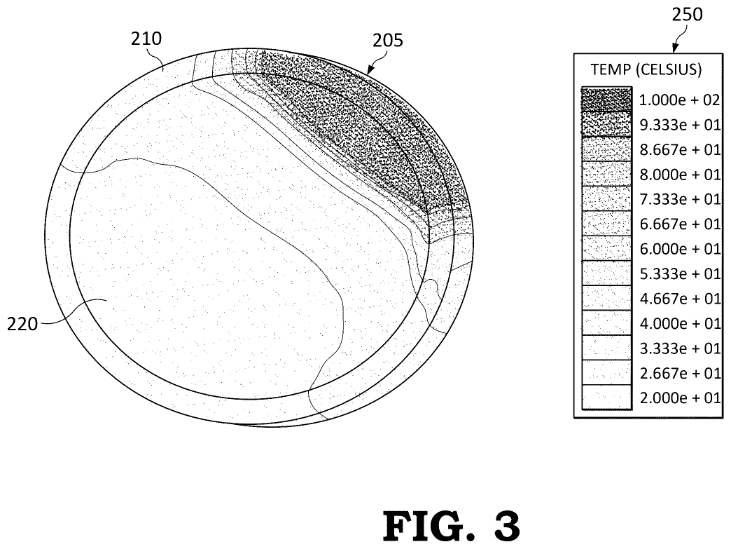

In the depicted example of FIG. 2, the PC lens 220 is coupled to the heat input 205 via approximately 50% surface contact between the plastic support frame 210 and PC lens 220. However, increasing the surface contact between support frame 210 and lens to 100% only provides marginal improvement, as shown in FIG. 3.

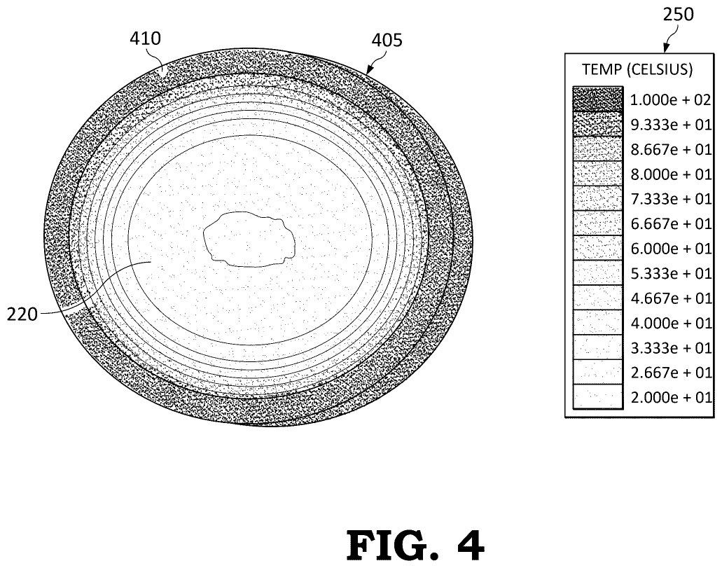

As noted above, in the embodiment of WHUD device 150, more thermally conductive materials are used for some or all of front frame 165 and/or portions of the temple arms 152, 154. FIG. 4 depicts a three-dimensional heat map of a magnesium-alloy support frame 410 coupled with approximately 50% contact to a typical PC lens 220. As observed from that 3D heat map, the magnesium-alloy support frame 410 excels at conducting heat away from the heat source components coupled to the support frame 410 at heat input 405, and thereby increases the surface area available to reject that heat to the ambient environment. However, the relatively low thermal conductivity and large surface area of the PC lens 220 remains a limiting factor for such heat conduction and rejection.

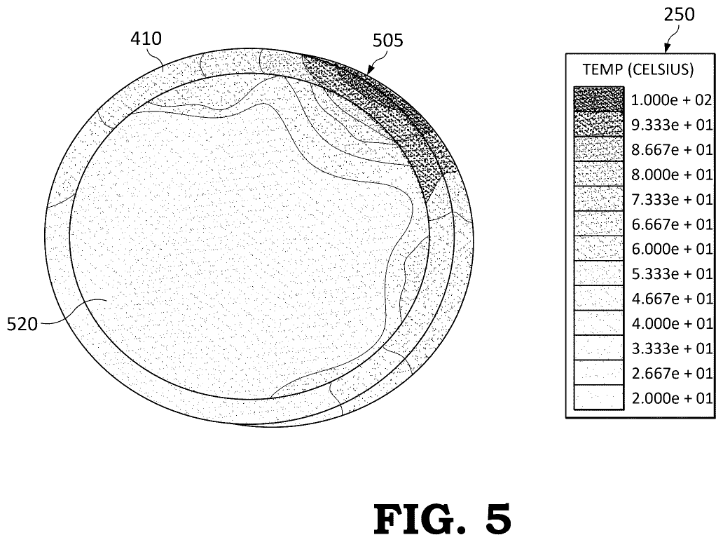

In contrast, FIG. 5 depicts a 3D heat map of the magnesium-alloy support frame 410 of FIG. 4 coupled with approximately 50% surface contact to a transparent heatsink lens 520 (which is substantially functionally similar to lens element 160 of FIG. 1-2) comprising an ALON lens material having a thermal conductivity of approximately 13 W/mK. As observed from that 3D heat map, the transparent heatsink lens 520 is approximately uniform in temperature despite the localized application of thermal energy at heat input 505. That is, virtually the entire surface area of the transparent heatsink lens 520 is being effectively utilized as a radiator to reject the heat input from components of the incorporating WHUD device (e.g., WHUD device 150) to the ambient environment.

In various embodiments, various techniques are utilized to increase the thermal contact between the support frame 410 and the transparent heatsink lens 520. For example, in certain embodiments thermal interface materials (including thermal grease, thermal paste, and/or conductive adhesives, as non-limiting examples) may be used to thermally couple the support frame 410 to the transparent heatsink lens 520. In addition, various embodiments advantageously leverage aspects of support frame geometry to directly couple heat source components of the WHUD device to the transparent heatsink lens 520, such as by forming and extending one or more flanges of the transparent heatsink lens into the support frame 410 at heat input 505 and into direct contact with one or more proximate heat source components. In this manner, thermal energy from the heat source components is transferred into the transparent heatsink lens 520 not only at the heat input 505, but also around the perimeter of the transparent heatsink lens 520 itself.

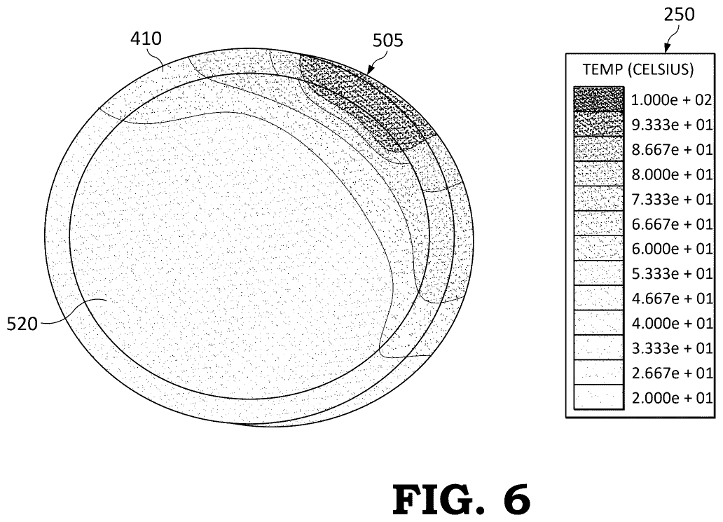

FIG. 6 depicts a 3D heat map of the magnesium-alloy support frame 410 coupled with approximately 100% contact (e.g., by using thermal interface material(s) and/or direct coupling) to the transparent heatsink lens 520. As shown, the increased thermal contact between the magnesium-alloy support frame 410 and the transparent heatsink lens 520 further increases the overall thermal conductivity.

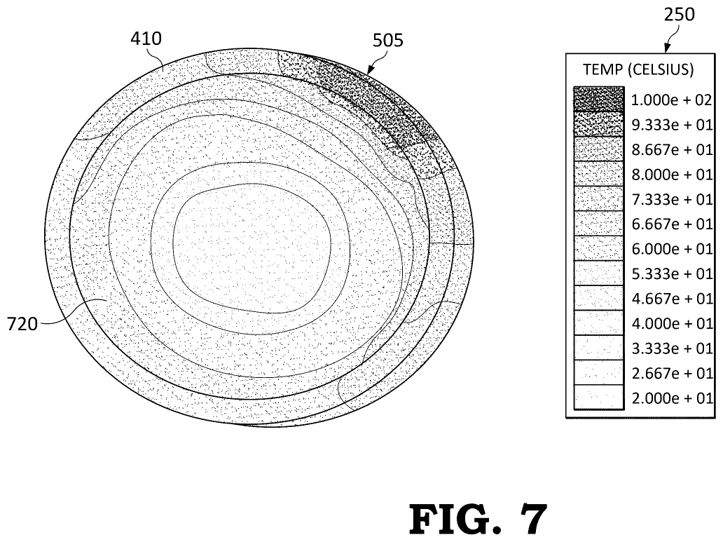

FIG. 7 depicts a 3D heat map of a magnesium-alloy support frame 410 coupled with approximately 100% surface contact with a less-conductive transparent heatsink lens 720. In the depicted embodiment, the transparent heatsink lens 720 comprises materials having an overall thermal conductivity of approximately 4 W/mK. As indicated, even with a lower overall thermal conductivity, the transparent heatsink lens 720 is still approximately uniform in temperature—that is, the surface area of the heatsink is still being effectively utilized to reject heat into the ambient environment and for intra-device conduction away from the heat source components. Thus, while higher thermal conductivity materials are desirable, significant benefit may still be achieved with comparatively lower thermal conductivity lens materials (which are nonetheless associated with relatively high thermal conductivity values compared to typical polycarbonate, PMMA, or glass lens materials). In certain embodiments, a transparent heatsink lens comprising materials (such as borosilicate) with an overall thermal conductivity of approximately 1.1 W/mK provides significant advantageous overall thermal conductivity when utilized via a relatively high surface contact with the higher thermal conductivity support frame 410.

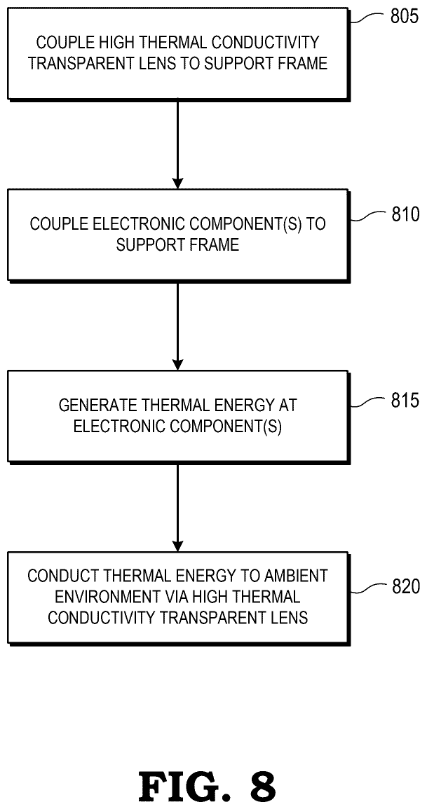

FIG. 8 is an operational flow diagram illustrating operations for increasing an overall heat rejection efficiency in a device with one or more electronic components, such as a WHUD device (e.g., WHUD device 150 of FIG. 1-2).

The routine begins at block 805, in which a substantially transparent lens having a relatively high thermal conductivity is coupled to a support frame. As discussed in greater detail elsewhere herein, in certain embodiments the support frame may also comprise materials with a relatively high thermal conductivity. The routine proceeds to block 810.

At block 810, the one or more electronic components are coupled to the support frame. The routine proceeds to block 815.

At block 815, the one or more electronic components generate thermal energy, such as (as one non-limiting example) a result of operations to display one or more images to a user via the substantially transparent lens. The routine proceeds to block 820.

At block 820, as a result of the relatively high thermal conductivity of the materials comprising the substantially transparent lens, conducting at least some of the generated thermal energy to the proximate ambient environment.

It will be appreciated that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A wearable heads-up display (WHUD) device, comprising:
one or more electronic components that, when in operation, generate thermal energy;
a support frame coupled to at least one of the one or more electronic components; and
at least one substantially transparent lens coupled to the support frame, wherein the at least one substantially transparent lens comprises one or more materials having a collective thermal conductivity value of at least approximately 1.1 Watt per meter Kelvin (W/mK).

2. The WHUD device of claim 1, wherein the at least one substantially transparent lens comprises one or more of a group of materials that includes borosilicate, fused silica, sapphire, aluminum oxynitride (ALON), or silicon carbide.

3. The WHUD device of claim 1, wherein the at least one substantially transparent lens includes a base material having a first thermal conductivity and one or more additional materials having a second thermal conductivity that is higher than the first thermal conductivity.

4. The WHUD device of claim 3, wherein the base material comprises one or more of a group that includes polycarbonate, borosilicate glass, or polymethyl methacrylate (PMMA), and the one or more additional materials comprises one or more of a group that includes sapphire, aluminum oxynitride (ALON), silicon carbide, silver particulate, graphite, or graphene.

5. The WHUD device of claim 3, wherein the base material comprises one or more of a group that includes borosilicate, fused silica, sapphire, aluminum oxynitride (ALON), or silicon carbide, and the one or more additional materials comprises one or more of a group that includes silver particulate, graphite, or graphene.

6. The WHUD device of claim 1, wherein the support frame comprises a front frame and one or more temple arms, and wherein at least the front frame comprises one or more of a group that includes a magnesium alloy, a titanium alloy, an aluminum alloy, a thermally conductive plastic, or a thermally conductive composite.

7. The WHUD device of claim 1, wherein the support frame is coupled to the at least one substantially transparent lens via one or more thermal interface materials, and wherein the one or more thermal interface materials comprise one or more of a group that includes thermal grease, thermal paste, or conductive adhesive.

8. The WHUD device of claim 1, wherein the at least one substantially transparent lens is directly coupled to the support frame and to at least one of the one or more electronic components.

9. The WHUD device of claim 1, wherein the at least one substantially transparent lens comprises one or more layers of an optical stack.

10. The WHUD device of claim 9, wherein the optical stack comprises one or more ophthalmically corrective lenses.

11. The WHUD device of claim 9, wherein the optical stack comprises one or more augmented reality (AR) display components.

12. A method, comprising:
generating thermal energy at one or more electronic components coupled to a support frame of a wearable heads-up display (WHUD) device; and
conducting the thermal energy to an ambient environment of the WHUD device via at least one substantially transparent lens coupled to the support frame, the at least one substantially transparent lens comprising one or more materials having a collective thermal conductivity of at least approximately 1.1 Watts per meter Kelvin (W/mK).

13. The method of claim 12, wherein conducting the thermal energy to the ambient environment via at least one substantially transparent lens includes conducting the thermal energy via a substantially transparent lens comprising one or more of a group of materials that includes borosilicate, fused silica, sapphire, aluminum oxynitride (ALON), or silicon carbide.

14. The method of claim 12, wherein conducting the thermal energy to the ambient environment via at least one substantially transparent lens includes conducting the thermal energy via a substantially transparent lens comprising a base material having a first thermal conductivity and one or more additional materials having a second thermal conductivity that is higher than the first thermal conductivity.

15. The method of claim 14, wherein the base material comprises one or more of a group that includes polycarbonate, borosilicate glass, or polymethyl methacrylate (PMMA), and the one or more additional materials comprises one or more of a group that includes sapphire, aluminum oxynitride (ALON), silicon carbide, silver particulate, graphite, or graphene.

16. The method of claim 14, the base material comprising one or more of a group that includes borosilicate, fused silica, sapphire, aluminum oxynitride (ALON), or silicon carbide, and the one or more additional materials comprising one or more of a group that includes silver particulate, graphite, or graphene.

17. The method of claim 12, the support frame comprising a front frame and one or more temple arms, and the front frame comprising one or more of a group that includes a magnesium alloy, a titanium alloy, an aluminum alloy, a thermally conductive plastic, or a thermally conductive composite.

18. The method of claim 12, the support frame being coupled to the at least one substantially transparent lens via one or more thermal interface materials, and the one or more thermal interface materials comprising one or more of a group that includes thermal grease, thermal paste, or conductive adhesive.

19. The method of claim 12, the at least one substantially transparent lens being directly coupled to the support frame and to at least one of the one or more electronic components.

20. The method of claim 12, the at least one substantially transparent lens comprising one or more layers of an optical stack that includes one or more of a group that includes one or more ophthalmically corrective lenses or one or more augmented reality (AR) display components.

21. A method, comprising:
coupling one or more electronic components to a support frame of a wearable device; and
coupling at least one substantially transparent lens having an overall thermal conductivity value of at least 1.1 Watts per meter Kelvin (W/mK) to the support frame.
